(19) United States
(12) Patent Application Publication
(10) Pub. No.: US 2004/0034968 A1
(43) Pub. Date: Feb. 26, 2004

(54) 360 Degree hinge and door closure apparatus

(75) Inventor: Charles E. Williams, Delavan, WI (US)

Correspondence Address: Daniel S. Jones, Michael Best & Friedrich LLP, 100 East Wisconsin Avenue, Milwaukee, WI, 53202-4108, US

(73) Assignee: Hufcor, Inc., Janesville, WI

(21) Appl. No.: 10/427,269

(22) Filed: May 1, 2003

Related U.S. Application Data
(60) Provisional application No. 60/389,010, filed on Jun. 14, 2002.

(51) Int. Cl. E05D 7/00

(52) U.S. Cl. 16/354

(57) ABSTRACT

A hinge assembly and door closure assembly. The assembly generally includes fork members with slots to receive a connector and gears, where one or more pins pivotally couple the gears and connector to the fork members, and where the connector maintains the gears in meshing engagement through substantially 360 degrees of pivotal movement between the fork members. The closure assembly generally includes a rack and pinion, a biasing mechanism, a slider mechanism, and an arm pivotally coupled to the slider mechanism and the pinion, wherein the arm rotates the pinion in response to pivoting of the door, and where rotation of the pinion causes the rack to move against the force of biasing mechanism.

The present application claims priority to co-pending provisional patent application No. 60/389,010, filed on Jun. 14, 2002.

### BACKGROUND

The invention generally relates to door hinging and closing mechanisms. In particular the invention relates to a door closure assembly and a 360 degree hinge assembly.

### SUMMARY

Other features and advantages of the invention will become apparent to those skilled in the art upon review of the following detailed description, claims, and drawings.

### BRIEF DESCRIPTION OF THE DRAWINGS

FIG. 1 illustrates an exemplary side view of an operable wall including a 360 degree hinge and door closure assembly embodying the invention.

FIG. 2 illustrates an exemplary perspective view of the 360 degree hinge assembly.

FIG. 3 illustrates an exemplary exploded view of the 360 degree hinge assembly.

FIG. 4 illustrates an exemplary end view of the top rail.

FIG. 5 illustrates an exemplary exploded view of the door closure assembly.

FIG. 6 illustrates an exemplary perspective view of the door closure assembly in a neutral condition.

FIG. 7 illustrates an exemplary perspective view of the door closure assembly in another operable condition.

FIG. 8 illustrates an exemplary top view of the door closure assembly in a neutral condition.

FIG. 9 illustrates an exemplary top view of the door closure assembly in another operable condition.

FIGS. 10A and 10B illustrate exemplary top views of the 360 degree hinge assembly and door closure assembly in a neutral and fully open position, respectively.

FIGS. 11A and 11B illustrate exemplary conditions associated with a position adjustment mechanism.

FIGS. 12A and 12B illustrate a top view of a block associated with the door closure assembly in two exemplary positions.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of letters to identify elements of a method or process is simply for identification and is not meant to indicate that the elements should be performed in a particular order.

### DETAILED DESCRIPTION

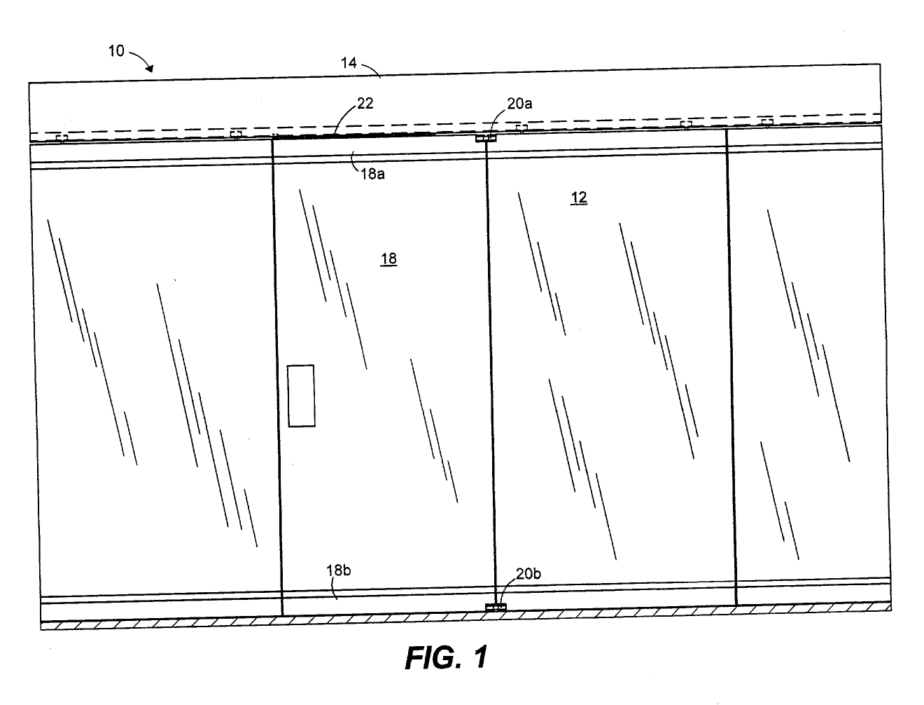

FIG. 1 illustrates an operable wall system 10 that includes a plurality of panels 12 suspended from a track or header 14 that is supported by the ceiling or other structural element of a room or building. The operable wall system may extend across the room between existing walls to divide the room into two smaller rooms. The operable wall includes a door 18, having a top rail 18a and a bottom rail 18b, that is pivotally interconnected to one of the panels 12 with 360 degree hinge assemblies 20a and 20b. A door closure assembly 22 is coupled to the top rail 18a and the header 14, and biases the door 18 to a closed or neutral condition, as illustrated in FIG. 1.

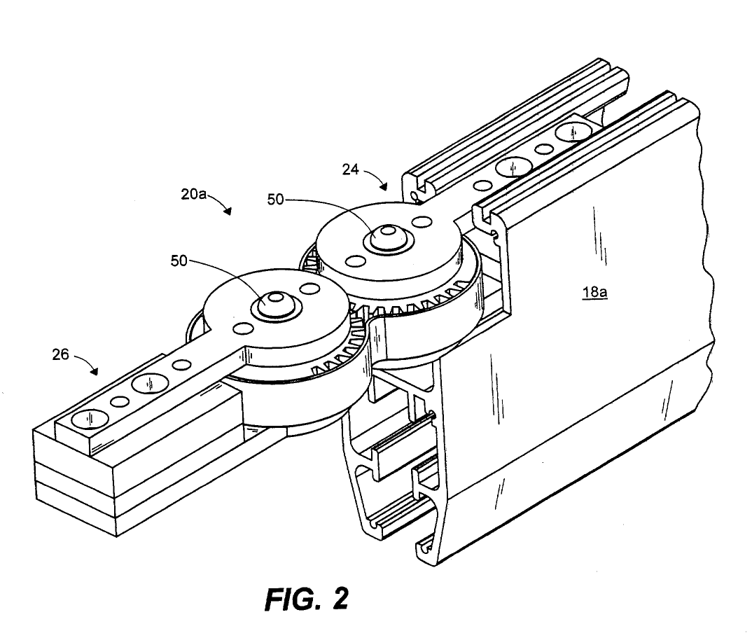

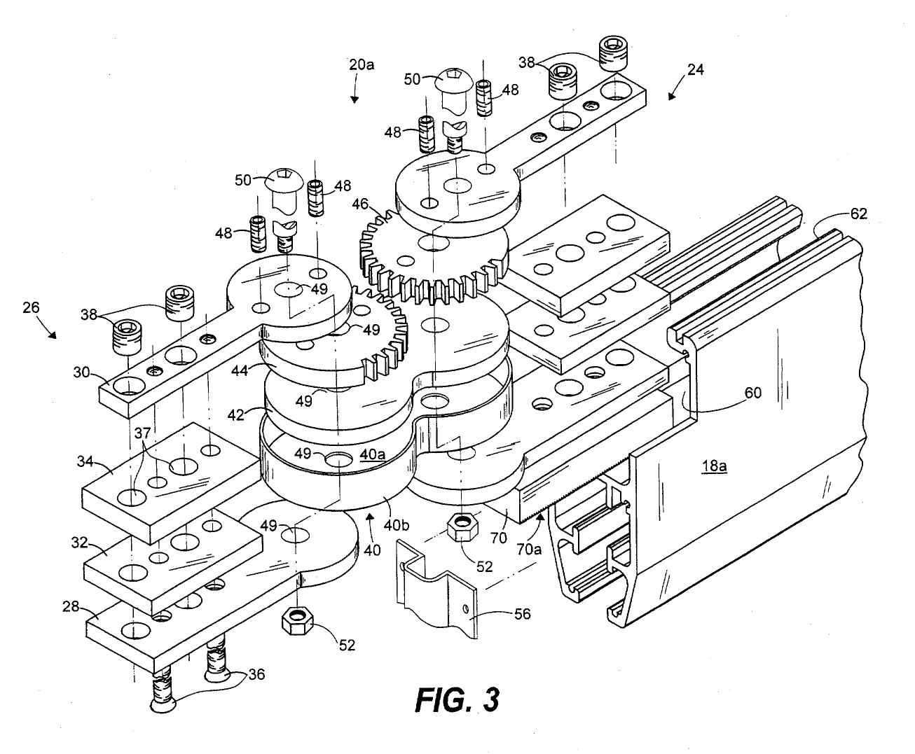

FIGS. 2 and 3 show the top 360 degree hinge assembly 20a for the top rail 18a of the door 18, it being understood that additional 360 degree hinge assemblies may be disposed at locations along the edge of the door 18 and that the bottom 360 degree hinge 20b is substantially identical to the upper hinge 20a, but upside down with respect thereto.

The 360 degree hinge assembly includes first and second fork members 24 and 26. The two sides of the hinge 20a are substantially mirror images of one another, therefore most parts are only numbered with respect to one fork member in FIG. 3. Each fork member 24, 26 includes a first and second arm 28 and 30, and two spacers 32 and 34 disposed between the first and second arms 28, 30. A slot is therefore defined between the overhanging portions of the arms 28, 30. The arms and spacers are interconnected with a pair of bolts 36 that extend through the first arm 28 and spacers 32, 34, and thread into the second arm 30. Threaded apertures 37 for set screws 38 extend through the arms 28, 30 and spacers 32, 34. The set screws 38 are used to secure the hinge in the top rail, as will be explained below. One should note that the relative direction of the bolts 36 and set screws 38 is not limited to the above configuration, and that other fastening means may be implemented to secure components associated with the 360 degree hinge assembly.

In one embodiment, a guard 40 is positioned within the slots of the fork members 24, 26, and includes a base 40a and a flange or wall 40b extending perpendicular to the base 40a and around the perimeter of the base to define a recess or cup therein. A connector 42 is positioned within the guard 40, as are a first gear 44 and a second gear 46. The connector 42 spaces the gears for meshing engagement and imparts structural stability to the hinge, while the guard prevents people's fingers and any foreign objects from entering the meshing zone between the gears 44, 46 from the sides. The guard 40 is made of relatively thin material and therefore provides no significant structural stability to the hinge. The gears 44, 46 have teeth over at least 180 degrees of their peripheries.

The first and second gears 44, 46 are connected to the second arms 30 of the respective fork members 24, 26 with suitable rivets or pins 48 to prevent the gears from rotating with respect to the second arms 30. One should note that the gears may be secured against relative rotation using a variety of fastening means, welding, or other metallurgical bonding and may, as an alternative, be mounted to the first arms 28. The wall 40b defined by the guard 40 preferably substantially covers the toothed portion of the gears. In other words, it is preferred that no portion of the gears extends outside the recess formed by the guard 40.

The gears 44 and 46 define a “footprint” or projected shape that includes a pair of lobes corresponding to the round gears, and a neck between the lobes corresponding to the meshing interengagement of the gears. Consequently, the footprint may be referred to as “figure-eight” in shape. The connector 42 and the guard 40 generally mimic this figure-eight footprint. The ends of the first arm 28 and second arm 30, which cover the top and bottom of the gears, are rounded to follow the shape of the gears 44 and 46. The rounded shape of the lobes of the guard wall 40b permits the edges of the door 18 and adjacent panel to remain very close to the guard wall 40b through the entire range of motion of the door 18. This helps reduce the amount of sound and light which passes through the hinge assembly.

The guard 40, connector 42, and gears 44 and 46 have holes 49 that align with holes in the first arm 28 and second arm 30. A pivot pin or shoulder bolt 50 extends through the holes and may be secured with suitable fastening means, for example a self-locking nut 52. In one embodiment, the head of the bolt 50 is a low profile head, such that the head is on top of the assembly for the upper hinge 20a on the door, and is on the bottom side of the assembly for the lower hinge 20b on the door. The threaded end of the bolt 50 and the nut 52 may typically be bulkier than the bolt head, but may be concealed within edge covers 56 on the edges of the door 18 and supporting wall panel 12.

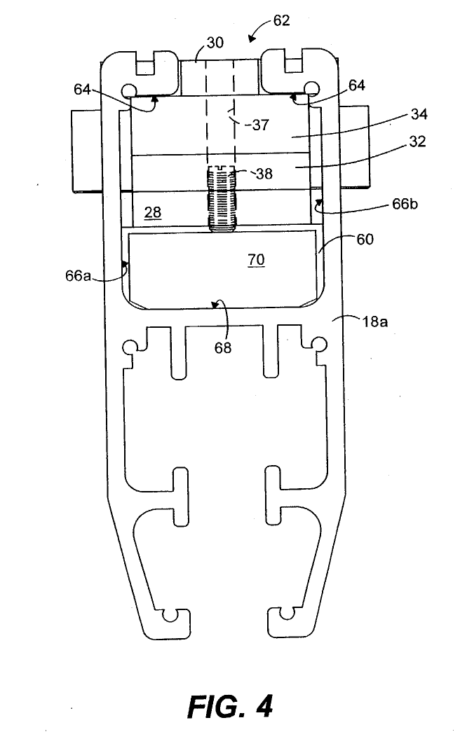

FIG. 4 illustrates an exemplary end view of the top rail 18a that includes a channel 60 having a top slot 62 defined between shoulders 64, sidewalls 66a and 66b, and a bottom wall 68. The second arm 30 of the hinge assembly is narrower than the first arm 28 so that it fits into the top slot 62 and keys itself to the top rail 18a. It should be noted that the bottom rail 18b (FIG. 1) of the door is similar to that illustrated, but it is turned upside down (as is the hinge assembly, as mentioned above). The supporting panels 12 of the operable wall may include similar top and bottom rails.

The ends of the forks 24 and 26 are inserted into the channels in the top rail of the door 18 and supporting panel 12. A block 70 is placed under the first arm 28 and against the bottom wall 68 of the channel 60. The set screws 38 are tightened such that they extend through the first arm 28 and press the block 70 against the bottom wall 68. In response, the spacer 34 is pressed against the shoulders 64 associated with the channel 60. The resulting pressure acting against the bottom wall 68 and shoulders 64 rigidly fixes the fork 26 in the top rail 18a. The other fork 24 in the 360 degree hinge assembly 20 may be secured, in a similar manner, to the top rail of the supporting wall panel 12, which has a substantially similar top rail 18a. As seen in FIG. 3, the block 70 may include ribs (indicated at 70a) to aid in securing the block 70 and fork 26 from sliding along the bottom wall of the channel 60.

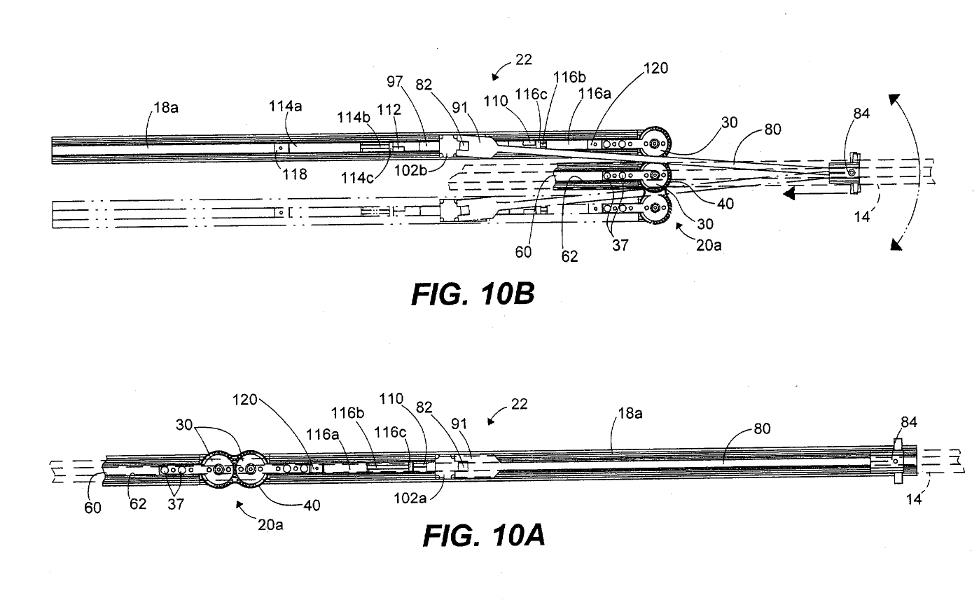

In operation, the 360 degree hinge assembly 20a, 20b permits the door 18 to open fully in both directions. Shown in FIGS. 10A and 10B are top views of the door 18 in a neutral and a fully open position. One should note that the direction of door swing is arbitrary as 360 degree hinge assembly 20a, 20b operates similarly in both directions. When the door is actuated such that it moves away from the closed or neutral condition, the door closure assembly 22 returns the door to the closed condition.

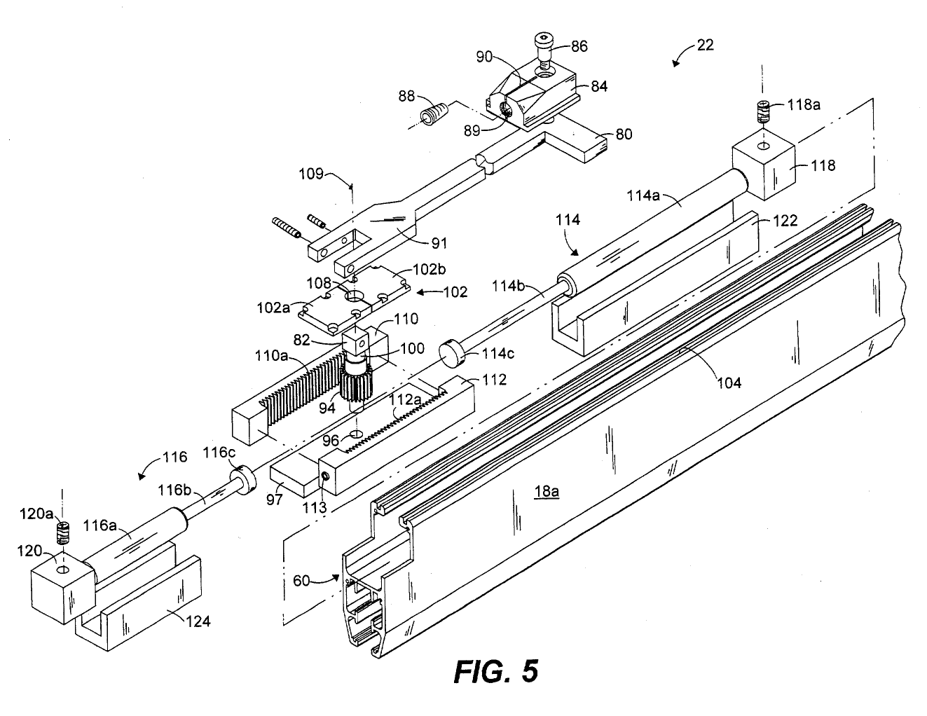

As noted above, the door closure assembly 22 is interconnected between the top rail 18a and the header 14. FIG. 5 illustrates an exemplary door closure assembly 22 including a closure arm 80 having one end coupled to a slider mechanism and another end coupled to a pinion 82. The slider mechanism is received in the header 14 (FIG. 1) and includes an elongated block 84. The block 84 has a hole to receive a fastener 86, such as a shoulder bolt, set pin, rivet, or the like, such that the block 84 is rotatably secured to the closure arm 80. Another end of the block 84 is tapered and includes a threaded bore or hole 89 to receive a tapered plug 88, such as a pipe plug or the like. The block 84 includes a cut or slice 90 extending into the block 84 along the longitudinal axis of the threaded hole 89. Thus, insertion of the plug 88 causes the tapered end of the block 84 to deflect or displace in proportion to the insertion depth of the plug 88. As will be described in further detail below, the position of the plug 88 may be used to change the speed at which the door closure assembly 22 operates.

The closure arm 80 is coupled to the pinion 82 using one of several possible attachment means. One exemplary attachment configuration, as illustrated in FIG. 5, includes a yoke section 91, formed on one end of the closure arm 80, which has a slot to receive a top portion or head of the pinion 82. In one embodiment, the top of the pinion 82 is flush with the top surface of the closure arm 80 to reduce the overall distance required between the top rail 18a and the header 14. The pinion 82 is received in the top rail 18a and includes a circular toothed portion 94 that extends into the channel 60. An end portion of the pinion 82 is supported by a pinion pivot hole 96 formed in a footing 97. The footing 97 may be secured to the bottom wall 68 of the channel 60 using any suitable fastening means or the footing 97 may be integrally formed with the bottom wall. The pinion 82 also includes a decreased diameter shoulder portion 100 that is trapped within a bearing assembly 102 fixed on a top surface 104 of the top rail 18a. The bearing assembly 102 includes a first half 102a and a second half 102b. Each half includes a semicircular recess 108 that, when disposed about the shoulder portion 100, prevents movement of the pinion 82 along the direction of a longitudinal axis 109 and supports the pinion 82 for rotation thereabout.

A first rack 110 and a second rack 112 are also disposed in the channel 60 and supported by the footing 97. The racks each include a toothed surface (110a and 112a respectively) configured for meshing engagement with the circular toothed portion 94 of the pinion 82. The engagement is such that rotation of the pinion 82 causes the racks 110 and 112 to move in opposite directions and along an axis transverse to the axis 109 of pinion rotation. As will be discussed further below, one end of one or both of the racks 110 and 112 may include an adjustment mechanism, such as a set screw 113 or the like. The adjustment mechanism permits a user to change the position of the top rail 18a (i.e., the door 18) in the neutral condition relative to the header 14.

The door closure assembly 22 also includes a biasing mechanism for urging the door 18 into the closed condition. FIG. 5 illustrates an exemplary biasing mechanism including a first pneumatic or gas-spring type cylinder 114 and a second pneumatic or gas-spring type cylinder 116 disposed in the channel 60. The cylinders 114 and 116 each include a housing (114a and 116a respectively) that is fixed at one end by respective stoppers 118 and 120. The stoppers may be press-fit into the channel 60 or secured using other fastening means, such as set screws 118a and 120a. One should note that the illustrated stoppers 118 and 120 are exemplary in shape and are not to be considered as limiting. The invention may be implemented using a variety of stopping means such that the first and second cylinders are prevented from sliding away from the pinion 82.

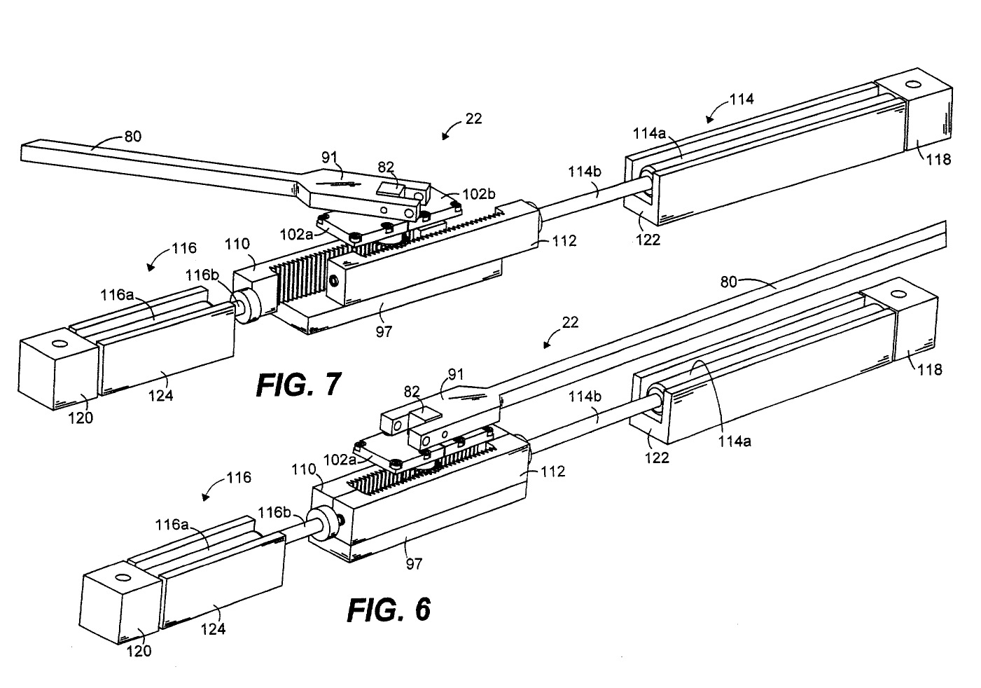

The cylinders 114 and 116 also each include an actuator or piston rod 114b and 116b, and a button or a plug 114c and 116c in contact with the ends of both racks 110 and 112 (or any position adjustment mechanism associated therewith). The plugs 114c and 116c are illustrated as circular disks however other shapes may be implemented. In operation, the first and second cylinders 114 and 116 respond to movement of the racks 110 and 112 toward them, and urge the racks 110, 112 back into a neutral position (FIG. 6).

Further, a first guide 122 and a second guide 124 may be placed in the channel 60 to support or guide the first cylinder 114 and second cylinder 116 respectively, and center the actuators 114b and 116b vertically and horizontally in the channel 60. The guides 122 and 124 may or may not be secured within the channel 60 and, in at least one embodiment, are optional.

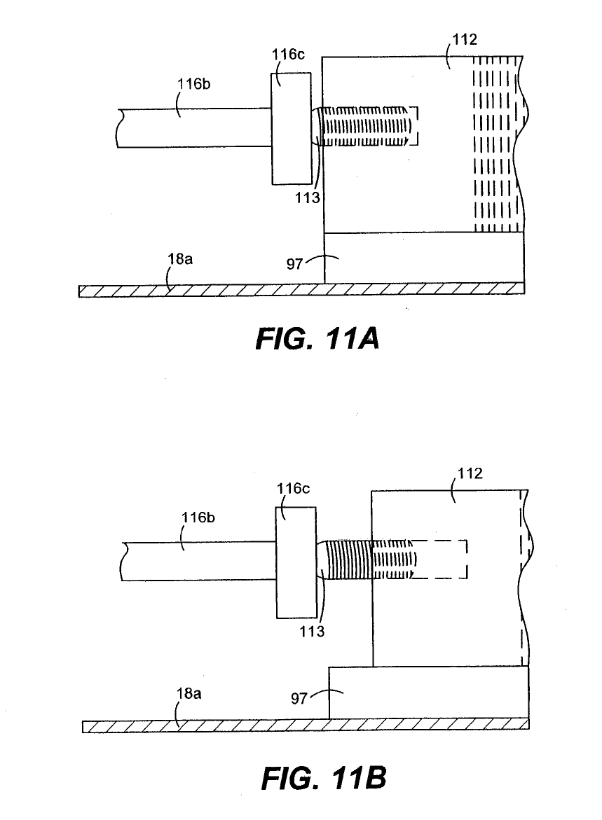

As mentioned above, a position adjustment mechanism, such as the set screw 113, may be located in one or more ends of the racks 110 and 112 and contacts one of the plugs 114c and 116c. FIGS. 11A and 11B illustrate two positions of an exemplary position adjustment mechanism. The set screw 113 may be adjusted so that the distance between the plug 116c and the end of the rack 112 is changed or offset. This adjustable offset allows “tuning” of the closure assembly so that the door 18 can be substantially parallel with the adjacent wall panels 12 when in the above-described closed condition.

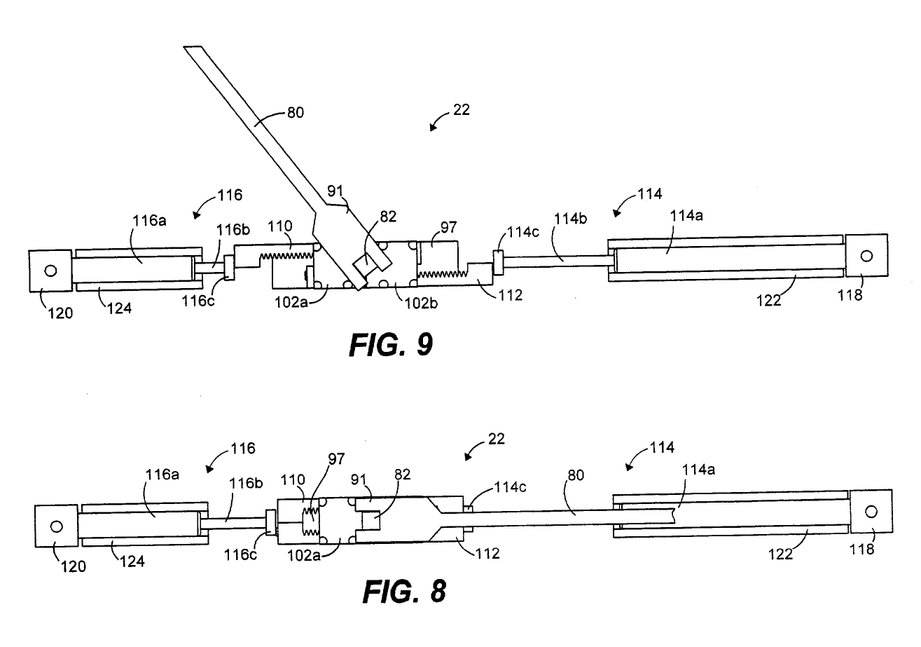

FIGS. 6 and 7 illustrate perspective views of the door closure assembly in exemplary operating conditions and FIGS. 8 and 9 illustrate top views of similar operating conditions. More specifically, FIG. 6 depicts door closure assembly 22 in the closed condition, which, as noted, is the case when the door 18 lies in substantially the same plane as the adjacent wall panels 12 (FIG. 1). One should also note that the top rail of the door is omitted from FIGS. 6-9 to aid in clarifying the operation of the components associated with the door closure assembly 22.

As shown in FIGS. 6 and 8, the closure arm 80 is substantially parallel with the longitudinal axis of the cylinders 114, 116 and thus the top rail 18a. For clarification, the orientation of the components associated with the door closure assembly 22 illustrated in FIGS. 6 and 8 may be referred to as the “neutral position.”

As noted above, FIGS. 7 and 9 respectively illustrate perspective and top views of components of the door closure assembly 22 configured for a door in a partially open condition. One should note that the direction of door swing is arbitrary as the door closure assembly 22 operates similarly in both directions. As the top rail 18a pivots away from the closed condition, the block 84 remains in the header 14. The closure arm 80 pivots accordingly and thus rotates the pinion 82. The tooth portion 94 of the pinion 82 rotates and causes the racks 110 and 112 to move, as described above, in opposite directions and away from the neutral position. Displacement of the racks 110 and 112 from the neutral position causes the actuators 114b and 116b to compress into their respective housings 114a and 116a in response to the biasing force imparted by the racks 110 and 112. The 360 degree hinge 20 and door closure assembly 22 allow the top rail 18a (i.e., door 18) to fully open in either direction such that the door lies in a plane substantially parallel and adjacent to the plane of the adjacent wall panels.

FIGS. 10A and 10B illustrate exemplary top views of the 360 degree hinge assembly 20a and the door closure assembly 22 for respective closed and open conditions of the top rail 18a of the door. It should be noted that FIGS. 10A and 10B illustrate a partial top view of an adjacent wall panel to show the fixed end of the hinge 20a received in the channel 60 and secured via set screws through apertures 37. In addition, a partial top view of the header 14 is illustrated in dashed lines to indicate the path of translation by the block 84 as the door swings to the open position. As shown in phantom (FIG. 10B), it should be understood that the door may be fully opened in either direction.

When the top rail 18a is pivoted away from the neutral condition, the biasing mechanism acts against such movement. Accordingly, when the door 18 is free from an external force, such as a person or object pushing on the door, the biasing mechanism closes the door. More specifically, the actuators 114b and 116b of the pneumatic cylinders impart a force on the racks 110 and 112 sufficient to move the racks 110 and 112 back toward each other, thereby rotating the pinion 82 and pivoting the closure arm 80. The speed at which the door closure assembly 22 returns to the neutral position may be at least partially controlled by the tension or friction established by the block sliding in the header.

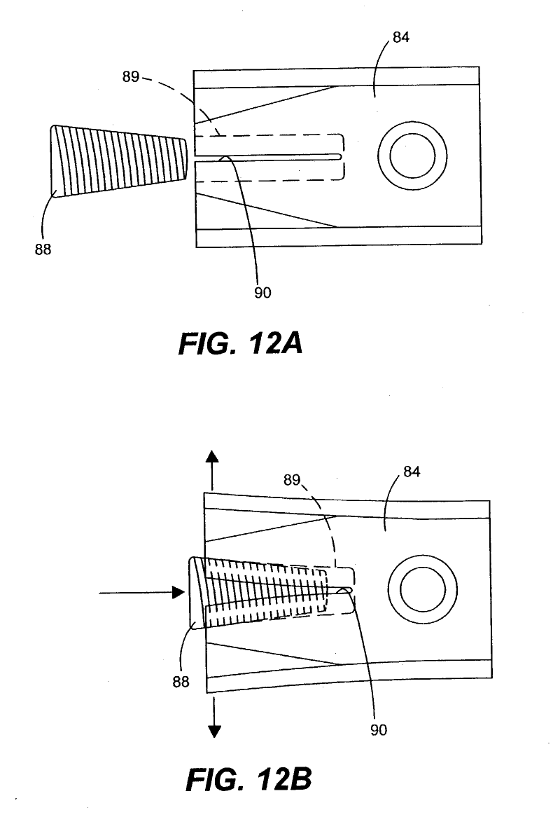

FIGS. 12A and 12B illustrate top views of the block 84 in two positions as defined by the insertion of the plug 88 into the threaded hole 89. More specifically, FIG. 12B depicts a correlation between the insertion of the plug 88 into the threaded hole 89 and the deflection of the sides of the block 84 as indicated by the arrows. As described above, the block 84 slides within a channel in the header 14 and the position or insertion depth of the tapered plug 88 modifies the amount force the deflecting sides of the block 84 exert on the channel walls in the header 14. The change in force corresponds to change in the amount of friction between the header 14 and the block 84 and may be used to control the speed at which the door closes.

It should be noted that although the biasing mechanism is described above to include two cylinders, embodiments of the invention may be implemented with a single gas-spring or pneumatic cylinder. If only one gas spring is used, it will bear on only one of the racks when the door is opened, and will push that rack toward the neutral position. The responsive rotation of the pinion will consequently cause the other rack to move back toward the neutral position from the opposite direction.

1. A hinge assembly for a door in a partition wall, the assembly comprising:
first and second fork members each having first and second arms and defining a slot between said first and second arms;
first and second gears positioned, respectively, within said slots of said first and second fork members;
a connector extending into said slots of both of said first and second fork members;
a first pin extending through said first arm of said first fork member, said first gear, a portion of said connector in said slot of said first fork member, and said second arm of said first fork member; and
a second pin extending through said first arm of said second fork member, said second gear, a portion of said connector in said slot of said second fork member, and said second arm of said second fork member;
wherein said first and second pins pivotally couple said first and second gears to said first and second fork members, respectively;
wherein said first and second pins pivotally couple said connector to said first and second fork members respectively; and
wherein said connector maintains said gears in meshing engagement through substantially 360 degrees of pivotal movement between said first and second fork members.

2. The assembly of claim 1, further comprising a guard extending into said slots of both of said first and second fork members, wherein said first and second gears and said connector are at least partially disposed within said guard.

3. The assembly of claim 1, further comprising a guard having a base and a flange extending generally transverse to said base along the entire perimeter of said base, wherein said base and flange together define a cup, and wherein said first and second gears are at least partially received within said cup.

4. The assembly of claim 3, wherein said guard extends into said slots of both of said first and second fork members, wherein said first and second pins extend through a portion of said base of said guard extending into the respective slots of said first and second fork members.

5. The assembly of claim 3, wherein said connector is at least partially received within said cup.

6. The assembly of claim 3, wherein said connector and said base of said guard generally mirror the footprint of said first and second gears when in meshing engagement.

7. The assembly of claim 6, wherein said connector and said base of said guard each include two lobes corresponding to the footprint of said first and second gears, and a neck connecting said two lobes and corresponding to the footprint of the meshing engagement of said first and second gears.

8. The assembly of claim 1, wherein said connector generally mirrors the footprint of said first and second gears when in meshing engagement.

9. The assembly of claim 1, wherein said connector includes first and second lobes corresponding to the shape of said first and second gears, respectively, and a neck corresponding to the shape of the meshing engagement between said first and second gears.

10. The assembly of claim 1, wherein said connector provides structural stability between the first and second fork members.

11. The assembly of claim 1, further comprising a guard extending into said slots of both of said first and second fork members, wherein said first and second gears and said connector are entirely disposed within said guard.

12. A door closure assembly for a door on a 360 degree hinge, the door including a top rail and being positioned under a header, the assembly comprising:
a first rack and a second rack slidably opposed to each other and disposed within the top rail, the first rack and second rack each having a row of teeth;
a pinion having a circular toothed portion in meshing engagement with the teeth of said first and second rack;
a first biasing member received in the top rail and in contact with the first rack;
a second biasing member received in the top rail and in contact with the second rack;
a block slidably received within the header; and
an arm pivotally coupled at one end to said block and affixed at another end to said pinion for rotation therewith;
wherein said block slides within the header in response to pivoting of the door out of a closed condition;
wherein the arm rotates the pinion in response to pivoting of the door out of the closed condition;
wherein rotation of the pinion causes said first and second racks to slide within the top rail away from a neutral position and against the biasing force of said first and second biasing members; and
wherein said first and second biasing members urge the door to return to the closed condition by biasing said first and second racks to said neutral position.

13. The assembly of claim 12, further comprising a footing coupled to the top rail and disposed beneath said first and second racks.

14. The assembly of claim 12, further comprising a bearing coupled to the top rail above said fist and second racks.

15. The assembly of claim 12, further comprising a first stopper and a second stopper received in the top rail;

16. The assembly of claim 15, wherein the first and second stoppers secure an end of the first and second biasing members respectively.

17. The assembly of claim 12, wherein at least one of the first and second racks includes a position adjustment mechanism.

18. The assembly of claim 17, wherein the position adjustment mechanism is operable to modify said neutral position.

19. The assembly of claim 17, wherein the position adjustment mechanism includes an adjustable set screw in at least one end of at least one rack, wherein at least one of the biasing members abuts the set screw.

20. The assembly of claim 12, wherein the bearing includes first and second halves that cooperate to surround a portion of the pinion.

21. The assembly of claim 12, wherein the block is elongated and includes a tapered end having an expansion mechanism.

22. The assembly of claim 21, wherein the expansion mechanism is operable to change the rate of rotation of the top rail relative to the header.

23. The assembly of claim 12, wherein the expansion mechanism includes a slot, a bore, and a tapered member received in the bore; wherein the width of said block is a function of the depth of the tapered member in the bore.

24. The assembly of claim 12, wherein at least one guide is disposed in the top rail and supports at least one of the first and second biasing members.

25. The assembly of claim 12, wherein the first and second biasing members include at least one of a gas spring and a pneumatic cylinder.

26. The assembly of claim 12, wherein the first and second biasing members engage opposite ends of the first and second racks such that each of the first and second biasing members is deflected when said first and second racks move in opposite directions.

27. A door closure assembly for a door on a 360 degree hinge, the door including a top portion and being positioned under a header, the door being pivotable substantially 180 degrees in opposite directions from a closed position, the assembly comprising:
a rack disposed in the top portion;
a pinion disposed in the top portion and engaged with the rack;
a biasing mechanism biasing the rack toward a neutral position corresponding to the door closed position;
a slider mechanism disposed in the header; and
an arm pivotally coupled at one end to slider mechanism and affixed at another end to the pinion for rotation therewith;
wherein the arm causes the slider mechanism to translate in the header and rotates the pinion in response to pivoting of the door in either direction out of the closed position;
wherein rotation of the pinion causes the rack to move within the top portion away from a neutral position and against the force of biasing mechanism; and
wherein the biasing mechanism biases the rack back to the neutral position to close the door.

28. The assembly of claim 27, wherein the biasing mechanism comprises at least one gas spring received in the top portion and abutting the rack.

29. The assembly of claim 27, wherein the rack includes a neutral position adjustment mechanism including a threaded bore in an end of the rack and a threaded member in the bore, said threaded member being rotatable to increase the effective length of said rack, wherein said biasing mechanism engages said threaded member.

30. The assembly of claim 27, wherein the slider mechanism includes an elongated block having a split portion and a threaded bore extending into said split portion, said assembly further comprising a tapered threaded plug threadably received within said bore in said block, wherein said split portion widens to create more friction between the block and the header in response to threading said plug deeper into said bore, and wherein said split portion narrows to reduce friction with the header in response to threading said plug shallower in said bore.

31. The assembly of claim 27, wherein the slider mechanism is adjustable to selectively modify the rate at which the door rotates relative to the header.

32. The assembly of claim 27, further comprising a bearing supporting an upper end of said pinion for rotation, wherein said bearing includes first and second halves mounted on opposite sides of said pinion to trap said upper end of said pinion therebetween.

33. The assembly of claim 32, wherein said pinion includes a shoulder that engages the bottom of said bearing to prevent said pinion from moving toward said bearing in a direction parallel to its axis of rotation.

34. The assembly of claim 27, wherein said rack includes a row of teeth and is slidably disposed within the top rail of the door, and wherein said pinion is rotatable with respect to said rack and includes a toothed portion in meshing engagement with the teeth of said rack.

36. The assembly of claim 27, further comprising a footing within the top portion, wherein said footing includes a pivot bore, and wherein said pinion includes a bottom end received within said pivot bore of said footing to facilitate rotation of said pinion with respect to said rack.
